(19) United States
(12) Patent Application Publication
(10) Pub. No.: US 2016/0074274 A1
(43) Pub. Date: Mar. 17, 2016

(54) MASSAGE TOOL

(71) Applicant: Rad Innovation LLC, Denver, CO (US)

(72) Inventor: Michael Mallory, Evergreen, CO (US)

(21) Appl. No.: 14/487,967

(22) Filed: Sep. 16, 2014

(51) Int. Cl. A61H 15/00

(52) U.S. Cl. CPC A61H 15/0092; A61H 2201/1669

(57) ABSTRACT

A massage tool includes a roller and a removable massage stick. The roller has a varying cross-sectional diameter along the length of the roller to enable myofascial release in both a transverse plane and in a sagittal plane when applied to the spine of a person. The removable massage stick that is inserted through the center of the roller along the length axis of the roller. The massage stick has two distal handles and center section that is independently moveable from the handles and that accommodates the roller when the massage stick is inserted through the center of the roller.

### BACKGROUND

The present invention relates to exercise equipment, and more specifically, to a set of tools allowing a user to self-apply massage to areas of the spine and other areas of the body, such as legs and arms.

Self-myofascial release (SMR) techniques are commonly used by athletes and physical therapists to aid in recovery of muscles that are prone to being overactive. Fascia is the soft tissue portion of the connective tissue in the muscle that provides support and protection. The fascia can become restricted due to overuse, trauma, and inactivity. Consequently, inflammation occurs and if it becomes bad enough the connective tissue can thicken, which results in pain and irritation, and additional inflammation.

One common SMR technique involves using a handheld roller massage stick, similar to a long, narrow, rolling pin, which works to increase circulation and helps to relieve tight muscles and prepare them for action. By rolling the roller massage stick over various muscle groups, such as gluteal muscles (“glutes”), thighs, back, shoulders, lattisimi dorsi (“lats”) and calves, etc., muscle tension can be massaged away and the overall recovery time can be reduced. Also, it can help correct muscle imbalances and reduce risk of injury and pain. However, many conventional roller massage sticks have too much surface area to be able to allow a user to work deeply and more precisely on specific muscles. Furthermore, it is typically difficult to access muscles that are positioned close to skeletal areas, such as the spine and the femur, using a conventional roller massage stick.

Another common SMR technique involves using a large foam roller, which is rolled under each muscle group until a tender area is found, and maintaining pressure by one's own body mass on the tender area for 30-60 seconds. Foam rollers come in different lengths, diameters, and with different hardness. However, foam rollers do not take into account the specific anatomy of the user, and can often cause too much (or too little) extension, for example, in the lumbar spine of a user, which could cause stress on the facet joints. Accordingly, there is a need for improved SMR techniques and devices for more precise massage of muscles, as well as devices for massaging the muscles that are positioned close to skeletal areas.

### SUMMARY

In accordance with a first aspect of the invention, a massage tool is provided. The massage tool includes a roller and a removable massage stick. The roller has a varying cross-sectional diameter along the length of the roller to enable myofascial release in both a transverse plane and in a sagittal plane when applied to the spine of a person. The removable massage stick that is inserted through the center of the roller along the length axis of the roller. The massage stick has two distal handles and center section that is independently moveable from the handles and that accommodates the roller when the massage stick is inserted through the center of the roller.

Various embodiments can include one or more of the following features. The roller can include a pipe extending along its center axis, and the pipe can have a coating of varying thickness along the length of the pipe. The pipe can be made from polyvinyl chloride or steel. The pipe can be coated with polyurethane. The coating can have a hardness in the range of approximately 45-55 durometers. The coating can have an indentation at a distance that is approximately half way between the distal ends of the roller. The roller and the massage stick can be used as individual massage tools when separated from one another.

The massage stick can include a central rod surrounded by a sleeve, and the sleeve can be divided into a center section and two distal sections. The center section of the sleeve can roll against the muscle of a user when in use, and the distal sections can be handles for holding the massage stick by a user. The central rod can be made from steel. The central rod can have a diameter of approximately ⅜ of an inch. The sleeve can be made from Polyvinyl Chloride.

A coating of silicone can be provided on the distal sections of the sleeve. A coating of Ethylene Vinyl Acetate can be provided on the center section of the sleeve. The massage stick can have a substantially uniform diameter through its entire length. The center section can be separated from each distal sections of the sleeve by a washer in order to minimize friction between the center section and the distal sections when the massage stick is in use. The roller can be designed to achieve an extension of the lumbar spine of approximately 35 degrees in the sagittal plane.

In accordance with a second aspect of the invention, a massage roller is provided. The massage roller includes a pipe extending along the center axis of the massage roller. The pipe has a polyurethane coating of varying thickness along the length of the pipe. The coating has an indentation at a distance that is approximately half way between the distal ends of the roller, which enables myofascial release in both a transverse plane and in a sagittal plane when the massage roller is applied to a person's back. The pipe is dimensioned to accommodate a removable massage stick, allowing for extended usability of the massage roller.

In accordance with a third aspect of the invention, a massage stick is provided. The massage stick includes a central rod made from steel. The central rod is surrounded by a sleeve made from polyvinyl chloride and has two distal handles and a center section that is independently moveable from the handles. The massage stick has a substantially uniform diameter through its entire length, rendering the massage stick insertable through the center of a massage roller along the length axis of the roller.

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 shows a plan view of a roller (100) in accordance with one embodiment.

FIG. 2 shows a cross-sectional view of a roller (100) in accordance with one embodiment.

FIG. 3 shows a roller massage stick (300) in accordance with one embodiment.

FIG. 4 shows an exploded view of the massage stick (300) of FIG. 3, in accordance with one embodiment.

FIG. 5 shows a detailed view of a section of the massage stick (300) of FIG. 4.

Like reference symbols in the various drawings indicate like elements.

### DETAILED DESCRIPTION

### Overview

The various embodiments of the invention provide a massage tool that can be used in various configurations for SMR. The massage tool is specifically designed for human anatomy, such that healthy spinal extension can be achieved and muscles can be pumped of lymph, while releasing collagenous restrictions and avoiding unhealthy stresses on the muscles. In one embodiment, the massage tool includes a roller and a massage stick. The massage tool and its various configurations will now be described by way of example and with reference to the drawings. However, as the skilled reader realizes, this is merely one embodiment and many variations that fall within the scope of the appended claims can be contemplated by those having ordinary skill in the art.

### Roller

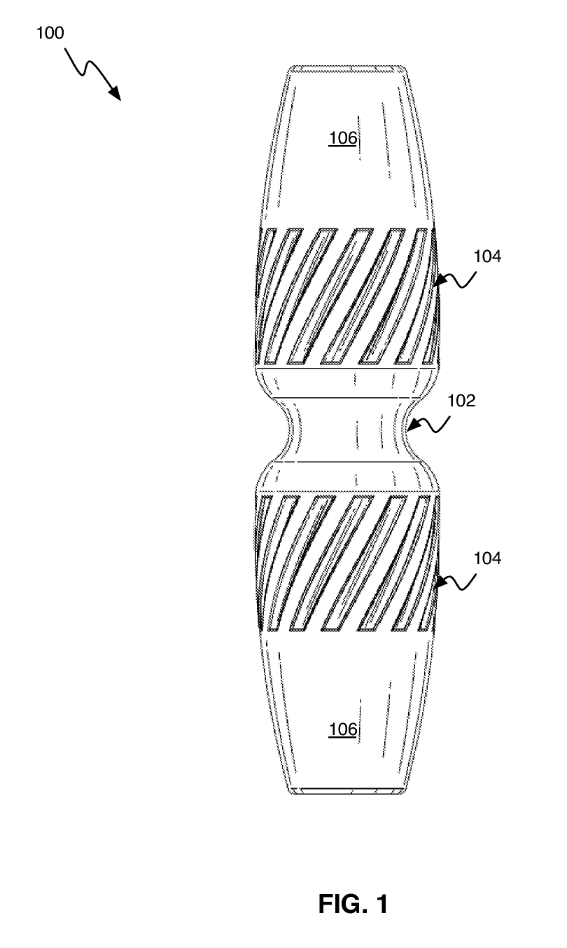

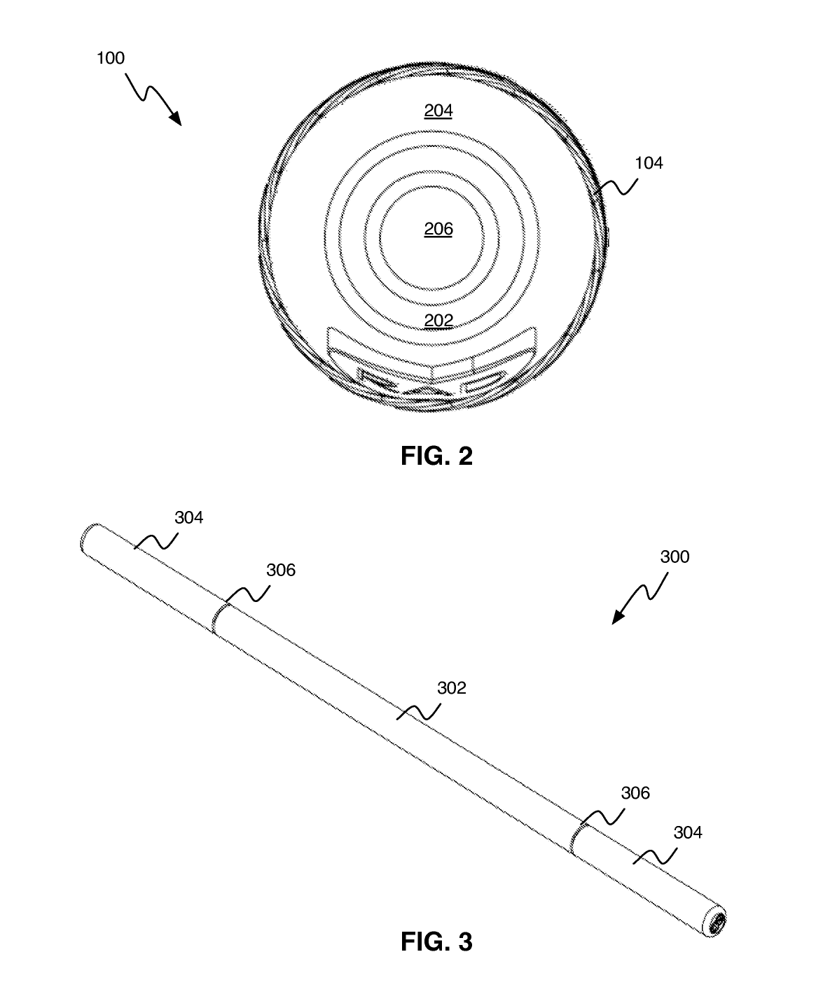

The first component of the massage tool is a roller, which is a tool for both keeping muscles healthy and supple through SMR, while being specifically sized and fitted in one embodiment for the lumbar spine. When a user lies down on top of the roller with the roller in the center of the lumbar spine and rolls back and forth, the low back muscles are pumped of lymph, while releasing collagenous restrictions. In one embodiment, the roller is designed to promote healthy lumbar spinal extension in the sagittal plane (i.e., bending backwards) by extending the lumbar spine around 35 degrees, which is a normal and healthy range for the lower back. As a contrast, a conventional 6-inch diameter foam roller may make for too much extension in the lumbar spine, while smaller rollers typically do not provide sufficient extension for the lumbar spine. In one embodiment, the roller has an arched design that aids the ribcage in extension and enhances the pressure in the erector spinae musculature. The roller will now be described in further detail with reference to FIGS. 1 and 2, which show a plan view and a cross sectional view of a roller (100) in accordance with one embodiment.

As can be seen in FIGS. 1 and 2, the roller (100) has an “hourglass-like” shape with an indentation (102) in the center of the length axis of the roller (100). The purpose of the indentation (102) is to accommodate the spinous process and prevent a user from putting too much pressure on the spine when the roller (100) is used. In the illustrated embodiment, the length of the roller (100) is 12.5 in and the diameter of the roller varies from 40 mm at the indentation (102) to 75 mm at its thickest part. However, it should be realized that these dimensions may change in various embodiments, which still would fall within the scope of the appended claims.

In the embodiment illustrated in FIGS. 1 and 2, the roller (100) includes a through rod (202) made from PVC (Polyvinyl Chloride). The through rod (202) provides the stability required for the roller (100) to work in a safe way. Without the through rod (202), the roller (100) would be too flexible to achieve an anatomically healthy range of bending for the low back. It should be noted that PVC is only one type of material that can be used for the through rod (202). In other embodiments, other types of rigid plastics, or even metals could be used as materials for the through rod (202) and the same functionality could be achieved.

The through rod has a coating (204) of Polyurethane, having a hardness of approximately 45 D. The thickness of the coating (204) varies along the length of the roller (100), and creates the unique shape of the roller (100). The use of Polyurethane and its shape allows the roller (100) to be safe, that is, not rigid and shaped for healthy extension in the low back. It should be noted that Polyurethane is only one type of material that can be used for the coating (204). In other embodiments, other types of polymers could be used as materials for the coating (204) and the same functionality could be achieved. Further, the hardness of 45 D is merely one example. Various embodiments can include hardness values in the range of approximately 40-55 D on the Shore D scale. Hardness values outside this range would either make the roller (100) too hard or too soft, and thus diminish its effectiveness for SMR.

In the illustrated embodiment, the sections of the roller (100) that are closest to the indentation (102) are provided with a ridge pattern (104) that is designed to create functional waves of pressure in the muscle tissue when in use.

The hollow space (206) inside the through rod (202) can accommodate the second component of the a massage tool, which is a massage stick that is longer than the roller (100), such that a portion of the massage stick extends out from either end of the roller (100). These protruding portions of the massage stick can be used as handles by a person, which allows for a partner to help massage the back of the user, similar to how a rolling pin would be used, instead of using the roller (100) by itself as an SMR tool, thus allowing for more flexibility in how the roller (100) is used. As will be described below, the massage stick can also be used as a stand-alone device for SMR. The massage stick will now be described in further detail and with reference to FIGS. 3-5.

### Massage Stick

The massage stick can in one embodiment work by itself as a myofascial release tool for SMR, which is used to both work out knots in muscle tissue via myofascial release, but also as a tool to keep muscle tissues mobile, flexible and supple. The massage stick in accordance with one embodiment is unique in particular because it has little or no flex during usage, and it also has a much thinner diameter rolling surface, which makes the surface area of usage much smaller than conventional handheld massage devices. As a result, it is much easier for a user to work deeper and more precisely on both small and large muscles. As was mentioned above, most conventional products have too much surface area to be able to work deeply. Furthermore, since the handles are flush with the center sleeve of the massage stick, it is easy for a user to roll the massage stick all the way up to the edge of the sleeve without being restricted.

FIG. 3 shows a perspective view of a massage stick (300) in accordance with one embodiment. As can be seen in FIG. 3, the massage stick (300) has a center portion (302) and two handles (304). When in use, a user holds on to the handles (304) and exerts some amount of pressure against whatever muscle group the user wishes to massage. The center portion (302) moves independently from the handles (304) and is rolled back and forth along the muscle when the user moves the handles. In order to reduce the friction between the handles (304) and the center portion (302) of the massage stick (300), in some embodiments, washers (306) can be provided.

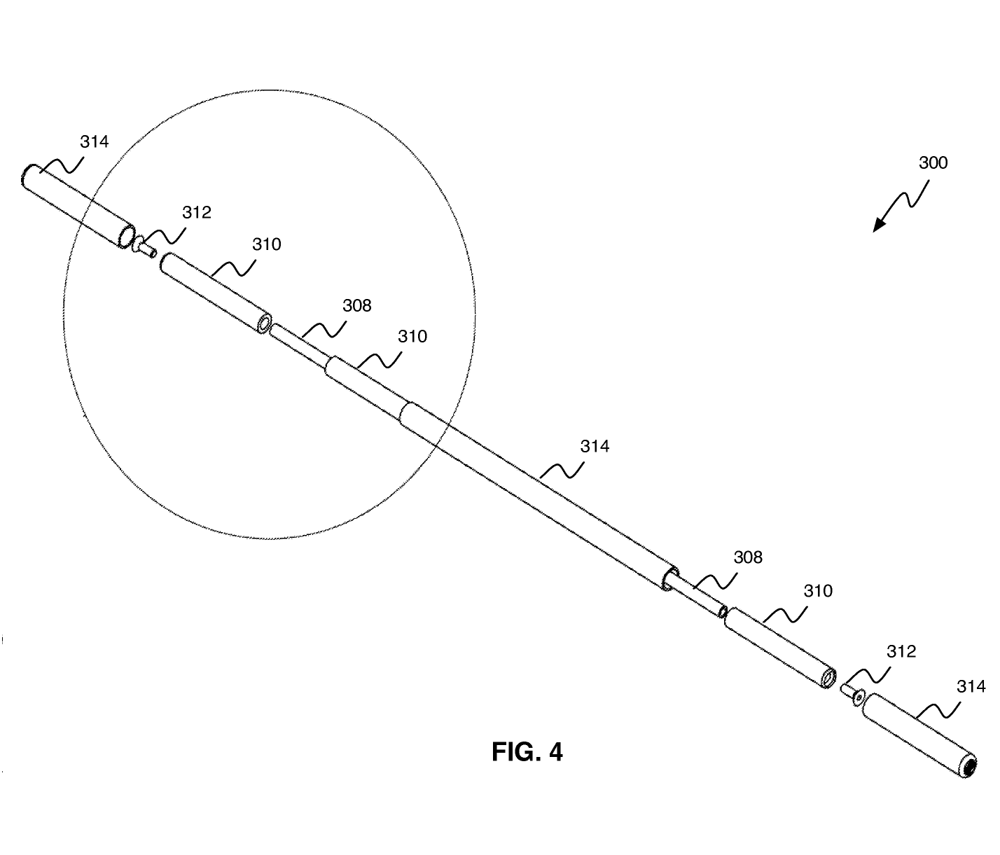

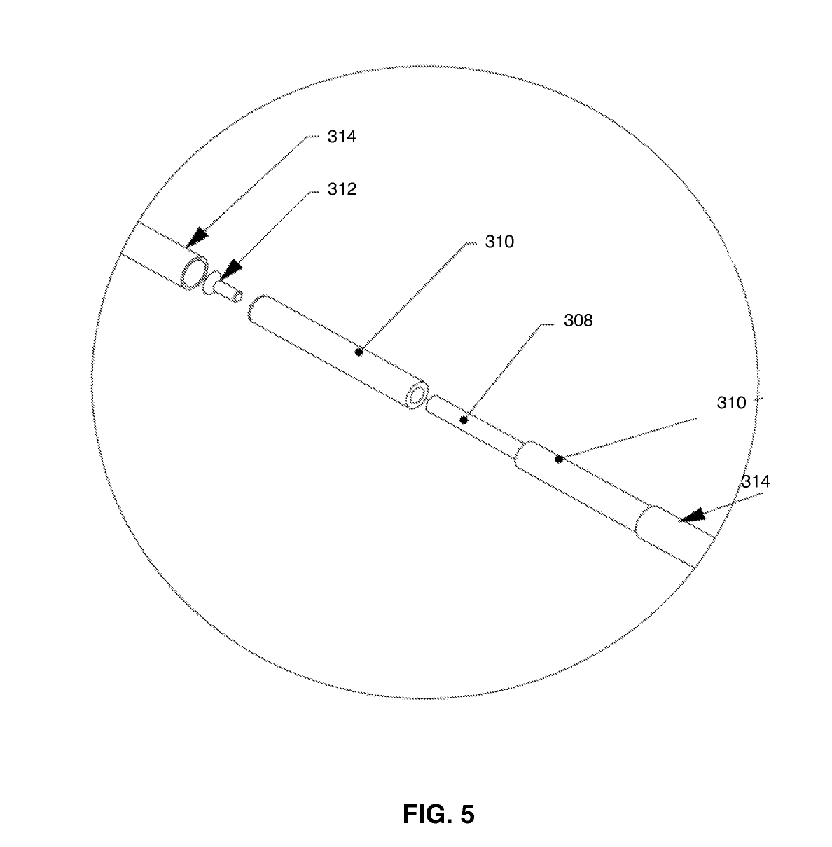

FIG. 4 shows an exploded view of a massage stick (300) in accordance with one embodiment, and FIG. 5 is a more detailed view of the components shown in the circle of FIG. 4. As can be seen in FIGS. 4 and 5, the massage stick (300) has a rod (308) at its center. The rod (308) is surrounded by a sleeve (310), which has two distal portions and a central portion, which together have approximately the same length as the rod (308). For ease of illustration, the washers (306) are not illustrated in FIGS. 4 and 5. The three parts of the sleeve (310) are held in place by bolts (312) that are threaded into the rod (308) at its respective ends. A coating (314) is provided on the outside of the different sleeve (310) parts to create a satisfying grip and an aesthetically pleasing look for the user.

In one embodiment, the rod (308) is a steel rod and the sleeve (310) is made from Poly Vinyl Chloride (PVC). Having a rod (308) made out of steel creates a low friction surface for the sleeve (310) to roll on. Further it allows for much less flexibility compared to conventional massage sticks. In one embodiment, the diameter of the rod (308) is approximately ⅜ inch. This diameter is smaller than conventional rods, thus making for less surface area and more precision and pressure available to a user.

In one embodiment, the coating (314) on the distal portions of the sleeve (310) is made from silicone and slides over each distal portion of the sleeve (310), where it is held in place through friction. The silicone provides a good grip for the user. The central portion of the sleeve (310) has a thin coating made from Ethylene Vinyl Acetate (EVA) foam, which also stays in place through friction. The EVA foam provides a soft barrier to the hard PVC sleeve (310) below, allowing the user to apply the massage stick (300) to more sensitive areas of the body, such as the shin, for example. Typically the thickness of the coating (314) of the central portion and the distal portions of the sleeve (310), respectively, are chosen such that the massage rod (300) has a uniform thickness throughout its length. This provides the user with more room to roll compared to conventional designs, which typically have some type of protruding flange separating the central rolling part (302) of the massage stick (300) from the handles (304).

It should be noted that the above materials and dimensions merely describe a few embodiments. The materials might change depending on the particular embodiment used. For example, various types of steel alloys can be used for the rod (308). Different polymers can be used for the sleeve (314), etc. The length of the massage stick (300) can vary, typically in the range of 18-22 inches, although lengths outside this range are also possible. Some embodiments may include a lubricant to further reduce the friction between the different moving parts of the massage stick (300), etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A massage tool, comprising:
a roller having a varying cross-sectional diameter along the length of the roller to enable myofascial release in both a transverse plane and in a sagittal plane when applied to the spine of a person; and
a removable massage stick that is inserted through the center of the roller along the length axis of the roller, the massage stick comprising two distal handles and center section that is independently moveable from the handles and that accommodates the roller when the massage stick is inserted through the center of the roller.

2. The massage tool of claim 1, wherein the roller includes a pipe extending along its center axis, and wherein the pipe has a coating of varying thickness along the length of the pipe.

3. The massage tool of claim 2, wherein the pipe is made from one or more of: polyvinyl chloride and steel.

4. The massage tool of claim 2, wherein the pipe is coated with polyurethane.

5. The massage tool of claim 2, wherein the coating has a hardness in the range of approximately 45-55 durometers.

6. The massage tool of claim 2, wherein the coating has an indentation at a distance that is approximately half way between the distal ends of the roller.

7. The massage tool of claim 1, wherein the roller and the massage stick are usable as individual massage tools when separated from one another.

8. The massage tool of claim 1, wherein the massage stick comprises a central rod surrounded by a sleeve, wherein the sleeve is divided into a center section and two distal sections.

9. The massage tool of claim 8, wherein the center section of the sleeve rolls against the muscle of a user when in use, and the distal sections are handles for holding the massage stick by a user.

10. The massage tool of claim 8, wherein the central rod is made from steel.

11. The massage tool of claim 8, wherein the central rod has a diameter of approximately ⅜ of an inch.

12. The massage tool of claim 8, wherein the sleeve is made from Polyvinyl Chloride.

13. The massage tool of claim 8, further comprising a coating of silicone on the distal sections of the sleeve.

14. The massage tool of claim 8, further comprising a coating of Ethylene Vinyl Acetate on the central on the center section of the sleeve.

15. The massage tool of claim 1, wherein the massage stick has a substantially uniform diameter through its entire length.

16. The massage tool of claim 8, wherein the center section is separated from each distal sections of the sleeve by a washer in order to minimize friction between the center section and the distal sections when the massage stick is in use.

17. The massage tool of claim 1, wherein the roller is designed to achieve an extension of the lumbar spine of approximately 35 degrees in the sagittal plane.

18. A massage roller, comprising:
a pipe extending along the center axis of the massage roller, the pipe having a polyurethane coating of varying thickness along the length of the pipe, wherein the coating has an indentation at a distance that is approximately half way between the distal ends of the roller, whereby myofascial release is enabled in both a transverse plane and in a sagittal plane when the massage roller is applied to a person's back, and wherein the pipe further is dimensioned to accommodate a removable massage stick, allowing for extended usability of the massage roller.

19. A massage stick comprising:
a central rod made from steel, wherein the central rod is surrounded by a sleeve made from polyvinyl chloride and comprising two distal handles and a center section that is independently moveable from the handles, wherein the massage stick has a substantially uniform diameter through its entire length, rendering the massage stick insertable through the center of a massage roller along the length axis of the roller.
